(19) United States
(12) Patent Application Publication
(10) Pub. No.: US 2024/0083362 A1
(43) Pub. Date: Mar. 14, 2024

(54) BAGGAGE LOADING DEVICE FOR A VEHICLE

(71) Applicants: HYUNDAI MOTOR COMPANY, Seoul (KR); KIA CORPORATION, Seoul (KR); SEOYON E-HWA CO., LTD., Anyang-si (KR)

(72) Inventors: Ji Ah Kim, Seoul (KR); Ji Seob Park, Incheon (KR); Jin Ho Hwang, Cheonan-si (KR); Hyung Won Jin, Gwangmyeong-si (KR)

(73) Assignees: HYUNDAI MOTOR COMPANY, Seoul (KR); KIA CORPORATION, Seoul (KR); SEOYON E-HWA CO., LTD., Anyang-si (KR)

(21) Appl. No.: 18/125,410

(22) Filed: Mar. 23, 2023

(30) Foreign Application Priority Data
Sep. 14, 2022 (KR) 10-2022-0115757

(51) Int. Cl. B60R 5/00

(52) U.S. Cl. CPC B60R 5/003; B60R 2011/0019

(57) ABSTRACT

A baggage loading device for a vehicle includes an auxiliary main body part provided to be drawn out from a sidewall in an interior of the vehicle and formed so that baggage can be selectively loaded when the baggage loading device is in a state of being drawn out.

### CROSS-REFERENCE TO RELATED APPLICATION

This application claims under 35 U.S.C. § 119(a) the benefit of priority to Korean Patent Application No. 10-2022-0115757 filed on Sep. 14, 2022, the entire contents of which are incorporated herein by reference.

### BACKGROUND

### (a) Technical Field

The present disclosure relates to a baggage loading device for a vehicle, and more specifically, to an interior loading device for a vehicle that fixes baggage to an interior space of the vehicle where a passenger and stored baggage may coexist.

### (b) Background Art

In general, a trunk of a vehicle is a space separated from an interior passenger space of the vehicle and is a space that is mainly used for transporting and storing various loaded items. Additionally, a trunk space is essential for many types of vehicles, and a size of the trunk space plays an important role in determining the merchantability of the vehicle.

Therefore, manufacturers are making great efforts to manufacture a larger trunk space within the limited size of a vehicle while considering the design, livability, fuel efficiency, performance, and the like of the vehicle in a design process.

In addition, in order to maximize the usability of the trunk space, a storage box, which may effectively store various items in the trunk is also provided. Additionally, an inner wall of the trunk is usually finished with a nonwoven fabric so that various items loaded in the trunk may be inhibited from sliding while the vehicle travels.

Nevertheless, when the vehicle travels with items loaded inside the trunk of the vehicle, the loaded items may still move about and may collide with each other or with the inner wall of the trunk. Thus, a problem may occur in that the loaded items may become broken or damaged.

Therefore, vehicles such as purpose built vehicles (PBAs) have been recently released in which interior spaces in which passengers inside the vehicle coexist with loaded items inside the interior spaces of the vehicle. As such, a purpose-built vehicle exists where the loaded items are stored in a passenger seat and not in the interior of the trunk. Thus, it is possible to not only improve accessibility to the loaded items but also to provide convenience in loading and unloading the loaded items.

However, when the loaded items are stored in the passenger seat as described above, it is desirable to not intrude upon the space where the passenger gets in the vehicle. Furthermore, when the loaded items are also stored in the passenger seat or the like, direct injury to the passenger may result if hit by a loaded item when separated from the passenger seat or the like. Thus, it is important to efficiently load a large number of loaded items while the loaded items are firmly fixed to the passenger seat or the like.

The above information disclosed in the Background section is only to enhance understanding of the background of the disclosure. Accordingly, the Background section may include information that does not form the prior art that is already known in this country to a person having ordinary skill in the art.

### SUMMARY

An object of the present disclosure is to provide a baggage loading device for a vehicle. The baggage loading device includes a plate drawn out from a driver partition at a predetermined height in a vehicle in which spaces where passengers may get in the vehicle and baggage may be stored. The baggage loading device has a multi-stage structure of a first loading layer and a second loading layer so that the baggage is loaded on the second loading layer in a state in which baggage is completely loaded on the first loading layer. Thus, the baggage loading device of a vehicle may allow or permit more baggage to be loaded on an inside of the vehicle and stably fix all baggage loaded on the first loading layer and the second loading layer.

In accordance with one embodiment of the present disclosure, a baggage loading device for a vehicle includes an auxiliary main body part provided to be drawn out from a sidewall of an interior of the vehicle and configured so that baggage can be selectively loaded on the auxiliary main body part when in a state of being deployed.

In addition, the baggage loading device may further include a main body part disposed to be spaced apart from a lower portion of the auxiliary main body part so that a loading area independent of the auxiliary main body part is formed and configured so that baggage can be loaded in the loading area.

The auxiliary main body part may be provided at at least one position among a plurality of different positions inside the vehicle constituting the sidewall.

In addition, the auxiliary main body part may include a case member stored in the sidewall, configured to move up or down and axially rotate along a guide bearing, and configured to have baggage loaded thereon in the drawn-out and deployed state. The auxiliary main body part may also include a drawn-out member drawn out by sliding through a guide pin from an inner side of the case member and extending from the case member.

The auxiliary main body part may further include a fixing member coupled to the drawn-out member and inserted into a supporter provided on a vehicle body to face the sidewall.

In addition, the auxiliary main body part may further include a plurality of bending members provided on the case member and/or the drawn-out member and having individually extendable lengths to be formed to surround and secure loaded baggage.

In addition, the auxiliary main body part may include a base member stored inside the sidewall, configured so that coupling pins protruding from both sides move up or down and axially rotate along a guide groove, and configured to have baggage loaded thereon in the drawn-out and deployed state. The auxiliary main body part may also include a folding member selectively unfolded from a state of being folded to face extend from the base member.

The guide grooves may be formed to a “L” shape and have the coupling pins positioned to be latched to a horizontal one end so that the base member is selectively inhibited from moving up or down.

In addition, the folding member may be provided in a shape corresponding to a shape of a supporter provided on a vehicle body to face the sidewall and to be selectively mounted on the supporter when unfolded.

In addition, the auxiliary main body part may further include a plurality of locking members mounted on a bottom surface of the folding member to slide when the folding member is unfolded and to accommodate a protrusion piece provided on a bottom surface of the base member to fix the folding member in the unfolded state.

In addition, the auxiliary main body part may include a first cover member stored in the sidewall and formed to move up or down and axially rotate along a guide bearing and a second cover member drawn out by sliding through a guide pin from the case member and extending from the first cover member.

The second cover member may include a fixing guide member unfolded while being drawn out from the first cover member and positioned to be latched to a latching groove formed in the first cover member to fix the second cover member in the unfolded state.

The fixing guide member may include a latching protrusion installed to axially rotate in the second cover member and configured to inhibit changing from the unfolded state to the folded state.

In addition, the auxiliary main body part may have inner portions of the first cover member and the second cover member formed of a mesh structure.

According to the present disclosure, a baggage loading device for a vehicle may include a plate drawn out from the driver partition at the predetermined height in the vehicle in which the spaces where the passengers may get in the vehicle and where baggage may be stored. The baggage loading device may have a multi-stage structure of a first loading layer and a second loading layer so that baggage can be loaded on the second loading layer in a state in which baggage is completely loaded on the first loading layer. Thus, the baggage loading device may allow more baggage to be loaded on the inside of a vehicle and stably fix all baggage loaded on the first loading layer and the second loading layer.

In addition, according to the present disclosure, it is possible to stably load the baggage in the second loading layer regardless of the arrangement direction of the second row seat. This is accomplished by the baggage loading device corresponding to the driver partition having different shapes according to the arrangement of the second row seat and adopting the plates having different structures and shapes.

In addition, according to the present disclosure, it is possible to prevent the baggage loaded on the first loading layer from being separated from the loading area. Thus, any injury to the passenger may be prevented due to the separation of the baggage inside of the vehicle by transforming the shape of the plate and allowing the plate, which is selectively drawn out, to be used for fixing the baggage loaded on the first loading layer.

It should be understood that the terms “automotive” or “vehicular” or other similar terms as used herein are inclusive of motor vehicles in general. Such motor vehicles may encompass passenger automobiles including sports utility vehicles (SUVs), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is an automobile that has two or more sources of power, such as for example vehicles that are both gasoline-powered and electric-powered.

The above and other features of the disclosure are discussed below.

### BRIEF DESCRIPTION OF THE DRAWINGS

The herein and other features of the present disclosure are now described in detail with reference to certain examples thereof illustrated in the accompanying drawings which are given herein below by way of illustration only, and thus are not limitative of the present disclosure, and wherein:

FIG. 1 is a view showing a baggage loading device for a vehicle according to one embodiment of the present disclosure;

FIGS. 2A-2E are views sequentially showing the drawn-out state of an auxiliary main body part of the baggage loading device for a vehicle according to one embodiment of the present disclosure;

FIG. 3 is a view showing a bending member of the baggage loading device for a vehicle according to one embodiment of the present disclosure;

FIG. 4 is a view showing a state in which baggage is loaded on the auxiliary main body part of the baggage loading device for a vehicle according to one embodiment of the present disclosure;

FIG. 5 is a view showing a baggage loading device for a vehicle according to a second embodiment of the present disclosure;

FIGS. 6A-6E are views sequentially showing the drawn-out state of the auxiliary main body part of the baggage loading device for a vehicle according to the second embodiment of the present disclosure;

FIG. 7 is a view showing a locking member of the baggage loading device for a vehicle according to the second embodiment of the present disclosure;

FIG. 8 is a view showing a baggage loading device for a vehicle according to another embodiment of the present disclosure;

FIG. 9 is a view showing the drawn-out state of the auxiliary main body part of the baggage loading device for a vehicle according to another embodiment of the present disclosure; and

FIG. 10 is a view showing a latching protrusion of the baggage loading device for a vehicle according to another embodiment of the present disclosure.

It should be understood that the appended drawings are not necessarily drawn to scale, presenting a somewhat simplified representation of various features illustrative of the basic principles of the disclosure. The specific design features of the present disclosure as described herein, including, for example, specific dimensions, orientations, locations, and shapes will be determined in part by the particular intended application and use environment.

In the figures, like reference numbers refer to the same or equivalent parts of the present disclosure throughout the several figures of the drawing.

### DETAILED DESCRIPTION

Hereinafter, the embodiments according to the present disclosure are described in detail with reference to the accompanying drawings.

Advantages and features of the present disclosure and a method of achieving the same should become apparent with reference to the embodiments described below in detail in conjunction with the accompanying drawings.

However, the present disclosure is not limited to the embodiments disclosed below and may be implemented in various different forms. The disclosed embodiments are provided so that the description of the present disclosure is thorough and complete and fully conveys the scope of the present disclosure to those having ordinary skill in the art to which the present disclosure pertains. The present disclosure is defined by the scope of the claims.

In addition, in the description of the present disclosure, where it has been determined that related known techniques may obscure the gist of the present disclosure, a detailed description thereof has been omitted.

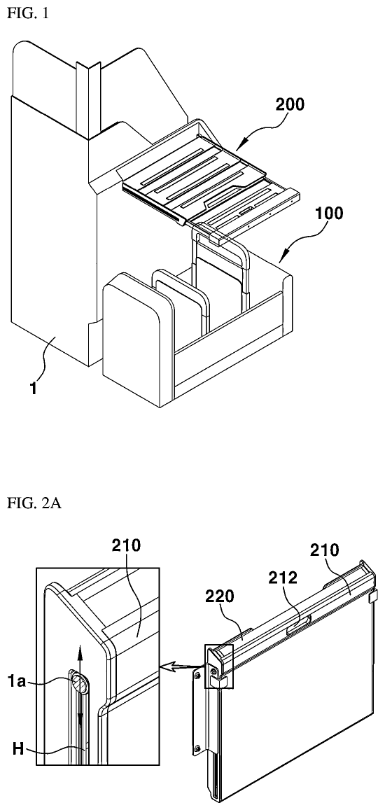

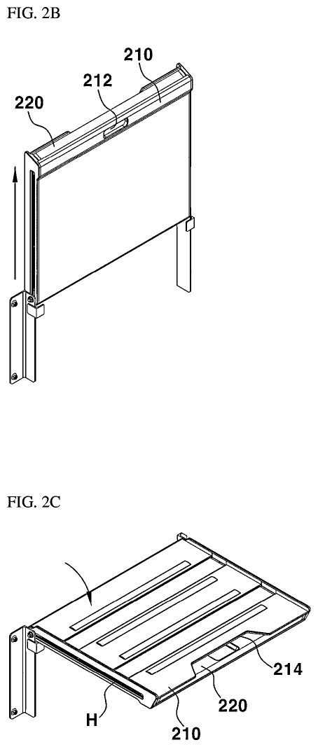

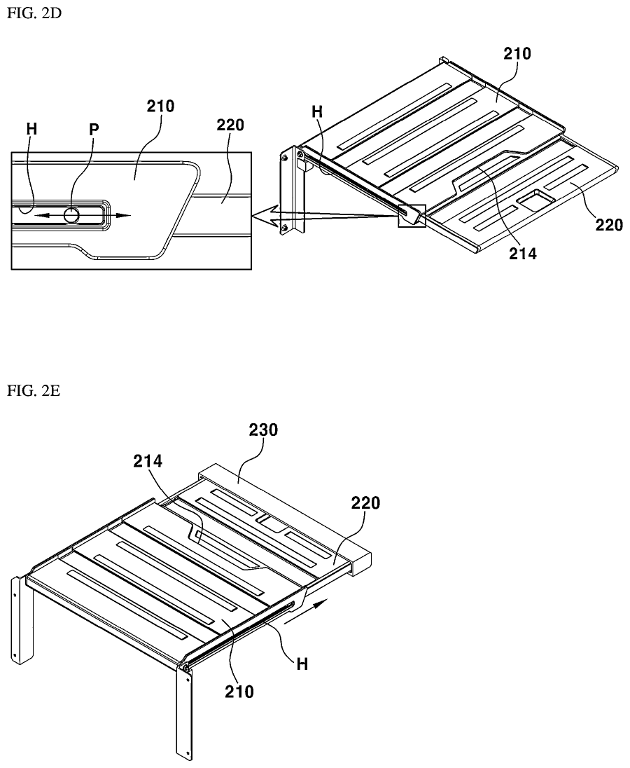

FIG. 1 is a view showing a baggage loading device for a vehicle according to one embodiment of the present disclosure. FIGS. 2A-2E are views sequentially showing the drawn-out state of an auxiliary main body part of the baggage loading device for a vehicle according to one embodiment of the present disclosure.

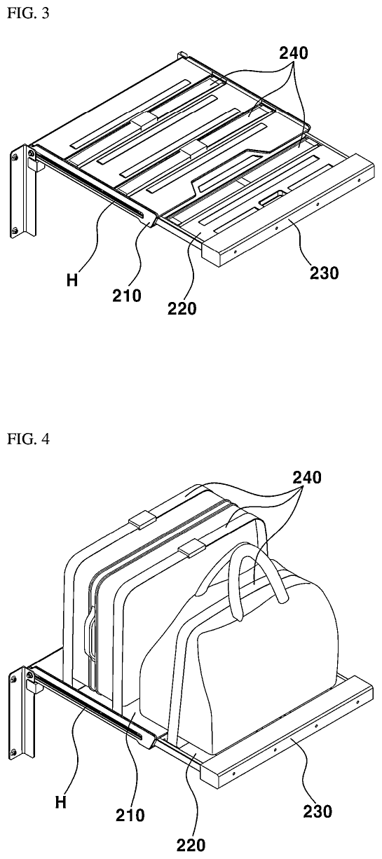

In addition, FIG. 3 is a view showing a bending member of the baggage loading device for a vehicle according to one embodiment of the present disclosure. FIG. 4 is a view showing a state in which baggage is loaded on the auxiliary main body part of the baggage loading device for a vehicle according to one embodiment of the present disclosure.

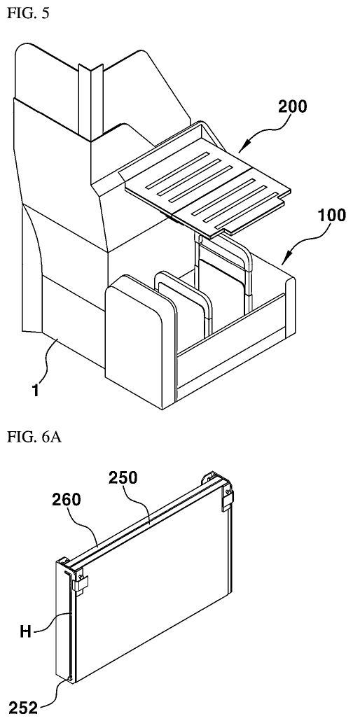

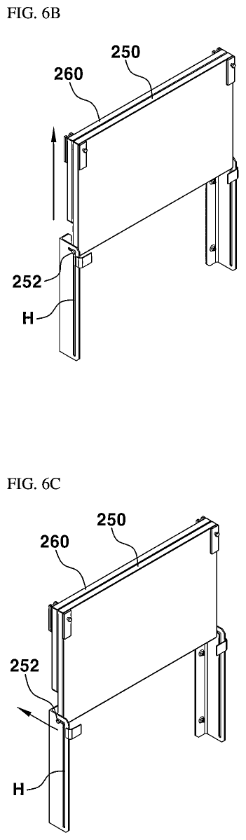

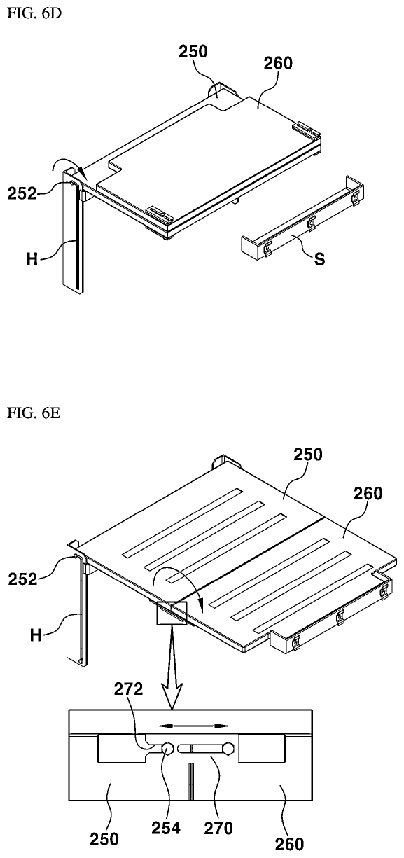

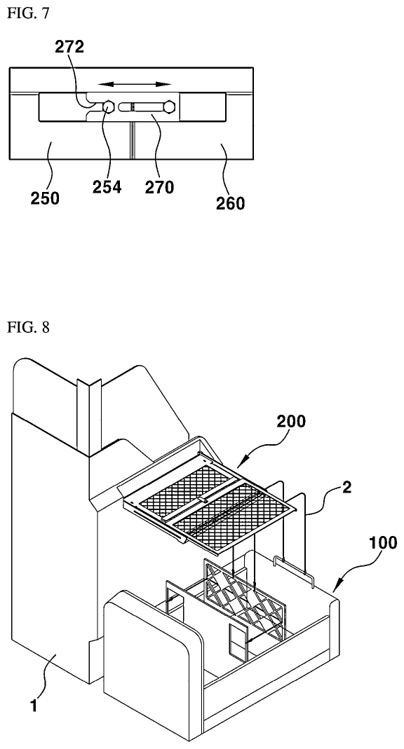

In addition, FIG. 5 is a view showing a baggage loading device for a vehicle according to a second embodiment of the present disclosure. FIGS. 6A-6E are views sequentially showing the drawn-out state of the auxiliary main body part of the baggage loading device for a vehicle according to the second embodiment of the present disclosure. FIG. 7 is a view showing a locking member of the baggage loading device for a vehicle according to the second embodiment of the present disclosure.

As shown in FIG. 1, a baggage loading device for a vehicle according to an embodiment includes a main body part 100 and an auxiliary main body part 200.

First, the main body part 100 is provided on a sidewall of a vehicle within the vehicle interior. The main body part 100 includes a loading area have a plurality of divided loading areas or spaces and is formed so that baggage or items can be loaded in the loading area.

The loading area may be formed to be partitioned or divided into three loading areas or spaces so that a standard or common carrier or container having a size of 24 inches may be loaded, for example.

The auxiliary main body part 200 is formed to allow an additional loading area in addition to the loading area of the main body part 100. The auxiliary main body part 200 is formed and provided to be drawn out from the vehicle sidewall in a direction of covering, i.e., to be positioned above the loading area of the main body part 100 at a predetermined height of the sidewall.

As in one of the embodiments, the auxiliary main body part 200 may be provided on the sidewall corresponding to a position of a partition 1 for partitioning a driver seat. Although not shown in the drawings, the auxiliary main body part 200 may also be provided at a position of the partition dividing a passenger seat and a luggage space constituting the sidewall in the vehicle, a conventional trim sidewall, a rear surface of the seat, a trim inner wall of the luggage space, or the like. The auxiliary main body part 200 may be provided at at least one position of a plurality of different positions in the vehicle constituting the sidewall. Thus, the vehicle interior sidewall that is associated with the disclosed baggage loading device may vary.

The auxiliary main body part 200 is formed to be extendable to a predetermined length through sliding movement and to this end, includes a case member 210 and a sliding or extendable member, i.e., a drawn-out member 220.

As shown in FIG. 2A, the case member 210 is stored in the side wall of the partition 1 and configured to both move up or down and axially rotate along a guide bearing 1a. Baggage or loaded items can be loaded in a state in which the case member 210 is slid or drawn up and pivoted or rotated out to a deployed state.

In other words, the case member 210 has a guide groove H having a length provided on both side surfaces. As shown in FIG. 2B, in a state in which the guide bearing 1a is positioned protruding through the guide groove H, when a user slides or moves the case member 210 up by gripping a handle 212, the case member 210 moves up along the guide bearing 1a.

In this state, when the case member 210 is then axially rotated about the guide bearing 1a, as shown in FIG. 2C, the case member 210 is rotated 90 degrees and positioned to an unfolded or deployed state. Thus, an additional loading area for the baggage may be formed.

In addition, the drawn-out member 220 is slidable and resides inside the case member 210. Guide pins P protrude from both sides of the drawn-out member 220 and can slide in a longitudinal direction inside the guide groove H. Thus, as shown in FIG. 2D, the additional loading area may be extended by sliding the drawn-out member 220 from the case member 210.

In addition, the case member 210 may be provided with a trapezoidal groove 214 or cut-out at the center to easily grasp and draw out the drawn-out member 220 (see FIGS. 2C and 2D). A part of the drawn-out member 220 that is exposed from the case member 210 may be effectively gripped through a configuration of the groove 214.

In addition, the auxiliary main body part 200 may further include a fixing member 230 coupled to the drawn-out member 220 and inserted into a supporter provided on a vehicle body to face the sidewall of the partition 1.

The fixing member 230 is formed in a shape corresponding to the shape and position of the supporter having a predetermined length and a groove shape. Thus, when the drawn-out member 220 is drawn out from the case member 210 and inserted into the supporter, the drawn-out state may be firmly fixed with the free end of the drawn-out member 220 and fixing member 230 supported by the supporter. As a result, the baggage may be effectively loaded by extending the additional loading area and fixing the drawn-out member 220 in the extended state.

In addition, as shown in FIG. 3, the auxiliary main body part 200 may further include a plurality of bending members 240 that is provided on the case member 210 and/or the drawn-out member 220. The bending members 240 may be belts, bands, straps, or strap-like and formed so that a length of each bending member 240 is individually extended by elasticity. Thus, the position of the loaded baggage may be fixed as shown in FIG. 4 by the bending members 240.

As shown in FIG. 6A, the auxiliary main body part 200 according to the embodiment may include a base member 250 and a folding member 260.

In other words, in the above-described embodiment, when a second row seat is disposed rearward, the rear of the partition 1 has a flat shape (see FIG. 1). However, when the second row seat is disposed forward, the rear of the partition 1 has a curved shape to secure a foot space of an occupant seated in the second row seat (see FIG. 5).

Therefore, when the auxiliary main body part 200 is stored in the sidewall of the partition 1 as in the above-described embodiment, interference occurs in the curved portion because of the length of the case member 210. Thus, inconvenience to the user may result not only when the auxiliary main body part 200 is stored but also when the auxiliary main body part 200 is drawn out.

To this end, the base member 250 is formed to move up or down and axially rotate along the guide groove H and to have the baggage loaded in the drawn-out state. Coupling pins 252 protrude from both sides and are together stored in the sidewall of the partition 1 in the state in which the folding member 260 is folded. Thus, the length of the auxiliary main body part 200 may be decreased, thereby preventing the occurrence of the problem.

As shown in FIG. 6B, when the base member 250 moves up to be drawn out, the guide groove H, which configured to guide a path in which it moves up or down, is formed to have a “L” shape. Thus, as shown in FIG. 6C, the coupling pin 252 moves up and then moves horizontally. The coupling pin 252 is then positioned to be latched to the horizontal one end so that the base member 250 may be selectively inhibited from to moving up or down.

As shown in FIG. 6D, the folding member 260 is provided in a shape corresponding to a shape of a supporter S provided on the vehicle body. Thus, one side surface of the folding member 260 to be unfolded faces the sidewall of the partition 1 and thus may be selectively mounted on the supporter S when unfolded.

As a result, since the drawn-out state of the auxiliary main body part 200 may be firmly fixed when the folding member 260 is unfolded and mounted on the supporter S, the additional loading area by the auxiliary main body part 200 and the additional loading area extended by the folding member 260 may be fixed. Thus, the baggage having a predetermined weight may be effectively loaded and supported.

Although not shown in the drawings, one or more bending members may be further provided in the embodiment. A plurality of the bending members can be provided on the base member 250 and/or the folding member 260 and formed so that the length of each bending member is individually extended by elasticity. Thus, the position of the loaded baggage may be fixed (see FIGS. 3 and 4).

In addition, the auxiliary main body part 200 may further include a locking member 270. The unfolded state of the folding member 260 may be fixed by the locking member 270.

In other words, as shown in FIG. 6E, the locking member 270 is mounted on each bottom edge of the folding member 260 and slides toward the base member 250 when the folding member 260 is unfolded. A protrusion piece 254 provided on a bottom surface of the base member 250 is accommodated in an accommodation groove 272 of the locking member 270. Thus, the unfolded state of the folding member 260 may be fixed.

When loading through the auxiliary main body part 200 is not required, the above-described unfolding operations of the base member 250 and the folding member 260 may proceed in a reverse order. More specifically, the locking member 270 slides so that the protrusion piece 254 is separated from the accommodation groove 272 so that the folding member 260 may be unlocked and folded with respect to the base member 250. The base member 250 may be axially rotated about the coupling pin 252 to make the base member 250 stand upright. Finally, the auxiliary main body part 200 may be stored by moving or sliding down the base member 250 in the state in which the folding member 260 is folded along the guide groove H.

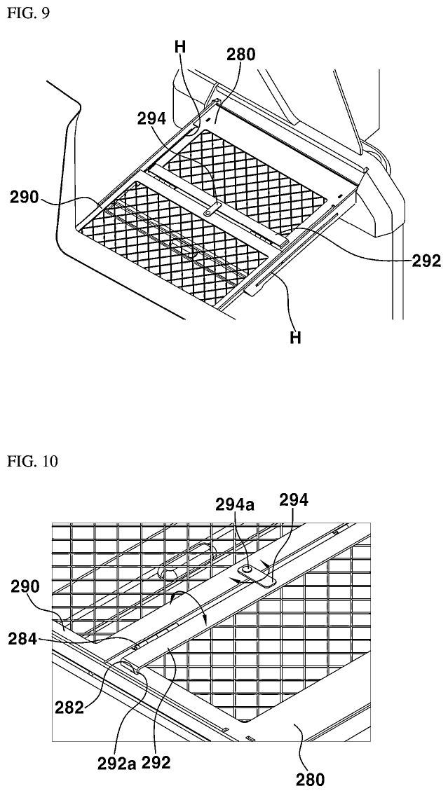

FIG. 8 is a view showing a baggage loading device for a vehicle according to another embodiment of the present disclosure. FIG. 9 is a view showing the drawn-out state of the auxiliary main body part of the baggage loading device for a vehicle according to another embodiment of the present disclosure. FIG. 10 is a view showing a latching protrusion of the baggage loading device for a vehicle according to another embodiment of the present disclosure.

As shown in FIG. 8, a baggage loading device for a vehicle according to the embodiment includes a main body part 100 and an auxiliary main body part 200.

The main body part 100 is provided with a loading area with a plurality of divided loading areas as in the above-described embodiments and is formed so that baggage is loaded in the loading area provided inside of a vehicle.

In addition, the auxiliary main body part 200 is provided on a side wall of the interior of the vehicle. Specifically, the side wall in the vehicle may be a side wall of a partition 1 configured to partition a driver seat. The auxiliary main body part 200 is provided to be drawn out in a direction of covering, i.e., to be positioned above the loading area from the side wall of the partition 1.

In an embodiment, the auxiliary main body part 200 may be provided on the side wall corresponding to a position of a partition 1 for partitioning a driver seat. Although not shown in the drawing, the auxiliary main body part 200 may also be provided at a position of the partition 1 dividing a passenger seat and a luggage space constituting the side wall in the vehicle, a conventional trim sidewall, a rear surface of the seat, a trim inner wall of the luggage room, or the like. Furthermore, the auxiliary main body part 200 may be provided at at least one position of a plurality of different positions in the vehicle constituting the sidewall. Thus, the vehicle interior sidewall that is associated with the disclosed baggage loading device may vary.

The auxiliary main body part 200 is formed to selectively block the separation of the baggage loaded in the loading area in the drawn-out state.

To this end, the auxiliary main body part 200 includes a first cover member 280 and a second cover member 290.

The first cover member 280 is stored in the side wall of the partition 1 and configured to move up or down. The first cover member 280 is also configured to axially rotate along a fixed guide bearing in a state in which the guide bearing is positioned outside a guide groove H.

In addition, although not shown in the drawing, the second cover member 290 is drawn out by sliding in a longitudinal direction in a state in which a guide pin is inserted into the first cover member 280. Thus the first cover member 280 may be extended as shown in FIG. 9.

The second cover member 290 includes a fixing guide member 292. As the second cover member 290 is drawn out from the first cover member 280, the fixing guide member 292 is rotated by a rotational guide member 284 in a state of being selectively unfolded, i.e., folded and selectively unfolded. As shown in FIG. 10, a protrusion 292a is positioned to be latched to an inner side of a latching groove 282 formed in the first cover member 280 to fix the second cover member 290 in the unfolded state.

In addition, the fixing guide member 292 may be installed to axially rotate about a rotational shaft 294a in the second cover member 290 and may include a latching protrusion 294 configured to limit the switching from the unfolded state to the folded state.

In other words, the protrusion 292a in the latching groove 282, formed in the first cover member 280, may be released due to an external impact or the like when the fixing guide member 292 is rotated by the rotational guide member 284 and switched from the folded state to the unfolded state. The latching protrusion 294 axially moves toward the first cover member 280 with respect to the rotational shaft 294a, thereby maintaining a state in which the protrusion 292a is positioned to be latched in the latching groove 282.

Although not shown in the drawings, a plurality of latching grooves 282 formed in the first cover member 280 may also be provided at predetermined intervals. Thus, the protrusion 292a may also be inserted into the latching groove 282 by adjusting a sliding position of the second cover member 290 in consideration of a position of a stopper (not shown) or the like and then rotating the fixing guide member 292.

The first cover member 280 and the second cover member 290 have inner sides formed in a mesh structure I this embodiment.

Specifically, since the auxiliary main body part 200 functions to block the separation of the baggage loaded in the loading area of the main body part 100, as in the above-described embodiment, the auxiliary main body part 200 may be damaged due to the baggage when it is formed in a rigid plate configuration. Thus, the main body part 200 may be advantageously formed in the mesh structure in order to prevent any damage.

In addition, when the mesh structure is formed as described above, as shown in FIG. 8, a plurality of separate straps 2 may be easily connected (fastened) to the mesh structure. Thus, the loading area of the main body part 100 may also be shielded to more effectively block the separation of the baggage loaded in the loading area.

According to the present disclosure, it is possible to provide a baggage loading device for a vehicle, which includes a plate drawn out from the driver partition at a predetermined height in the vehicle in the spaces where the passengers may get in the vehicle and baggage may be stored. The baggage loading device further has a multi-stage structure of a first loading layer and a second loading layer so that the baggage is loaded on the second loading layer in a state in which baggage is completely loaded on the first loading layer. Thus, the baggage loading device may allow more baggage to be loaded on the inside of the vehicle and stably fix all baggage loaded on the first loading layer and the second loading layer.

In addition, according to the present disclosure, it is possible to stably load the baggage in the second loading layer regardless of the arrangement direction of the second row seat. This is permitted by the baggage loading device corresponding to the driver partition having different shapes according to the arrangement of the second row seat and adopting the plates having different structures and shapes.

In addition, according to the present disclosure, it is possible to prevent the baggage loaded on the first loading layer from being separated from the loading area and thus preventing any injury to the passenger due to the separation of the baggage inside of the vehicle. This is accomplished by transforming the shape of the plate and allowing the plate, which is selectively drawn out above the first loading area or layer, to be used for fixing the baggage loaded on the first loading layer.

Although the present disclosure has been described above with reference to the embodiment(s) shown in the drawings, this is only illustrative. It should be understood by those having ordinary skill in the art that various modifications may be made therefrom and all or part of the above-described embodiment(s) may also be configured by being selectively combined. Therefore, the true technical scope of the present disclosure should be determined by the technical spirit and scope of the appended claims.

What is claimed is:

1. A baggage loading device for a vehicle, the baggage loading device comprising:
an auxiliary main body part provided to be drawn out from a sidewall of an interior of the vehicle and configured so that baggage can be selectively loaded when the auxiliary main body part is drawn out.

2. The baggage loading device of claim 1, further comprising:
a main body part disposed to be spaced apart from a lower portion of the auxiliary main body part so that a loading area independent of the auxiliary main body part is configured so that baggage can be loaded in the loading area.

3. The baggage loading device of claim 1, wherein the auxiliary main body part is provided at at least one position among a plurality of different positions inside the vehicle constituting the sidewall.

4. The baggage loading device of claim 1, wherein the auxiliary main body part includes:
a case member stored in the sidewall, the case member configured to move up or down and axially rotate along a guide bearing and to have baggage loaded thereon when in a deployed state, and
a drawn-out member that is drawn out by sliding through a guide pin from an inner side of the case member and extending from the case member.

5. The baggage loading device of claim 4, wherein the auxiliary main body part further includes a fixing member coupled to the drawn-out member and inserted into a supporter provided on a vehicle body to face the sidewall.

6. The baggage loading device of claim 4, wherein the auxiliary main body part further includes a plurality of bending members provided on the case member and/or the drawn-out member and having an individually extendable length to be formed to surround loaded baggage on the auxiliary main body part.

7. The baggage loading device of claim 1, wherein the auxiliary main body part includes:
a base member stored inside the sidewall, the base member configured so that coupling pins protruding from both sides move up or down and axially rotate along a guide groove, and to have baggage loaded thereon in a deployed state; and
a folding member that can be selectively unfolded from a state of being folded to extend from the base member.

8. The baggage loading device of claim 7, wherein the guide groove is formed to a “L” shape and has the coupling pins positioned to be latched to a horizontal one end so that the base member is selectively inhibited from moving up or down.

9. The baggage loading device of claim 7, wherein the folding member is provided in a shape corresponding to a shape of a supporter provided on a vehicle body to face the sidewall and selectively mounted on the supporter when unfolded.

10. The baggage loading device of claim 7, wherein the auxiliary main body part further includes a plurality of locking members mounted on a bottom surface of the folding member to slide when the folding member is unfolded and accommodate a protrusion piece provided on a bottom surface of the base member to fix the folding member in the unfolded state.

11. The baggage loading device of claim 1, wherein the auxiliary main body part includes:
a first cover member stored in the sidewall and configured to move up or down and axially rotate along a guide bearing; and
a second cover member drawn out by sliding through a guide pin from a case member and extending from the first cover member.

12. The baggage loading device of claim 11, wherein the second cover member includes a fixing guide member unfolded while being drawn out from the first cover member and positioned to be latched to a latching groove formed in the first cover member to fix the second cover member in the unfolded state.

13. The baggage loading device of claim 12, wherein the fixing guide member includes a latching protrusion installed to axially rotate in the second cover member and configured to inhibit changing from the unfolded state to a folded state.

14. The baggage loading device of claim 11, wherein the auxiliary main body part has inner portions of the first cover member and the second cover member formed of a mesh structure.
